(19) United States
(12) Patent Application Publication
(10) Pub. No.: US 2005/0125559 A1
(43) Pub. Date: Jun. 9, 2005

(54) Employment of one or more identifiers of one or more communication devices to determine one or more internet protocol addresses

(76) Inventor: Kailash K. Mutha, Aurora, IL (US)

Correspondence Address: PATTI & BRILL, ONE NORTH LASALLE STREET, 44TH FLOOR, CHICAGO, IL, 60602, US

(21) Appl. No.: 10/726,046

(22) Filed: Dec. 2, 2003

(51) Int. Cl. G06F 15/16

(52) U.S. Cl. 709/245; 709/203

(57) ABSTRACT

One or more server components of an apparatus employ one or more identifiers of one or more communication devices to make a determination of one or more internet protocol addresses of one or more router components. The one or more identifiers comprise any one or more of a phone number for one or more users associated with the one or more communication devices, an email address for the one or more users associated with the one or more communication devices, an instant message name for the one or more users associated with the one or more communication devices, and a user name for the one or more users associated with the one or more communication devices.

### TECHNICAL FIELD

The invention relates generally to telecommunications and more particularly to determination of internet protocol addresses.

### BACKGROUND

Users of communication devices place phone calls or send messages to other users of communication devices. The phone calls comprise one or more of a landline call, a data call, and a voice over internet protocol call (“VoIP”). For landline calls, the communication devices in one example send the phone calls through a public switched telephone network (“PSTN”). For the data calls or the voice over internet protocol calls, the communication devices send the phone calls through the internet. The messages comprise emails and instant messages. The communication devices in one example send the emails and the instant messages over the internet to the other communication devices.

The communication devices in one example send the phone calls, emails, and the instant messages over the internet to one or more internet protocol addresses of the other communication devices. The internet protocol addresses are known by the communication devices before sending the phone calls, emails, and the instant messages. As one shortcoming, for the communication devices to place the phone call over the internet, the communication device must know the internet protocol address of the other communication devices to place the phone call. As another shortcoming, the communication device cannot send phone calls over the internet to internet protocol addresses that change over time, for example, dynamic internet protocol addresses.

Thus, a need exists for internet protocol address determination of one or more recipient communication devices for one or more originating communication devices.

### SUMMARY

The invention in one implementation encompasses an apparatus. The apparatus comprises one or more server components that employ one or more identifiers of one or more communication devices to make a determination of one or more internet protocol addresses of one or more router components. The one or more identifiers comprise any one or more of a phone number for one or more users associated with the one or more communication devices, an email address for the one or more users associated with the one or more communication devices, an instant message name for the one or more users associated with the one or more communication devices, and a user name for the one or more users associated with the one or more communication devices.

Another implementation of the invention encompasses a method. One or more databases are searched with one or more identifiers of one or more communication devices to make a determination of one or more internet protocol addresses of one or more router components. One or more messages or calls are sent to the one or more internet protocol addresses of the one or more router components for direction to the one or more communication devices.

A further implementation of the invention encompasses an article. The article comprises one or more computer-readable signal-bearing media. The article includes means in the one or more media for searching one or more databases with the one or more identifiers of one or more communication devices to make a determination of one or more internet protocol addresses of one or more router components. The article includes means in the one or more media for sending one or more messages or calls to the one or more internet protocol addresses of the one or more router components for direction to the one or more communication devices.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises one or more communication devices, one or more server components, one or more databases, the Internet, one or more router components, and one or more network components.

FIG. 2 is a representation of a message flow for exemplary assignment and registration of one or more internet protocol addresses by the server component and the router component of FIG. 1.

FIG. 3 is a representation of a message flow for exemplary assignment and registration of one or more internet protocol addresses by the server component, the communication device and the router component of FIG. 1.

FIG. 4 is one representation of a message flow illustrating a communication of one or more messages or calls between the communication devices, the server components, and the router components of FIG. 1.

FIG. 5 is another representation of a message flow illustrating a communication of one or more messages or calls between the communication devices, the server components, and the router components of FIG. 1.

### DETAILED DESCRIPTION

The apparatus 100 in one example comprises one or more communication devices 102 and 104, one or more server components 106, 107, and 108, one or more databases 110 and 112, the Internet 114, one or more router components 116, and one or more network components 118 and 119. The communication device 104 in one example comprises one or more identifiers. The server component 106 in one example employs the identifiers of the communication devices 104 to make a determination of an internet protocol (“IP”) address of the router component 116. The server component 106 in one example passes one or more messages or calls from the communication devices 102 to the internet protocol address of the router component 116. The server component 108 in one example employs the router component 116 to direct one or more of the messages or calls to one or more of the communication devices 104, as described herein.

A user 130 of the communication device 102 in one example sends the messages or calls over the internet 114, the network component 118, or the network component 119 to one or more users 132 of the communication devices 104. The communication device 102 in one example comprises one or more of a computer, an internet telephone, a landline telephone, and a mobile communication device. The communication device 104 in one example comprises one or more of a telephonic device 120, a computer 122, a television 124, a smart appliance 126, a voice mailbox, and an answering machine. The message or call in one example comprises one or more of an email, an instant message, a telephone call, a voice mail, a video message, and an instruction for the smart appliance 126.

Where the communication device 102 comprises the landline telephone, the communication device 102 in one example sends the message or call over the network component 118 to the router component 116. The network component 118 in one example comprises a public switched telephone network (“PSTN”). Where the communication device 102 comprises the computer, the internet telephone, or the mobile communication device, the communication device 102 in one example sends the message or call over the internet 114 to the router component 116.

Where the communication device 102 comprises the mobile communication device, the mobile communication device in one example employs an H.323 protocol to send the message through the internet 114 to the internet protocol address of the router component 116. Where the communication device 102 comprises the mobile communication device, the communication device 102 in one example sends the message or call over the network component 119 to the router component 116. For example, the router component 116 receives the call or message from the network component 119 through a fixed wireless interface. The network component 119 in one example comprises a public land mobile network (“PLMN”).

The router component 116 receives the message or call from the internet 114, the network component 118, or the network component 119. The router component 116 in one example is located in a home or an office. The router component 116 comprises an instance of the data recordable storage medium 128. The server component 107 in one example assigns an internet protocol address to the router component 116. For example, the internet protocol address of the router component 116 comprises a static internet protocol address or a dynamic internet protocol address. The router component 116 the internet protocol address of the router component 116 with the server component 106. The router component 116 may later re-registers with the server component 106 to ensure reliability of internet protocol translation of the router component 116.

The server component 106 in one example employs an identifier of the communication device 104 to make a determination of the internet protocol address of the router component 116. The identifier in one example comprises one or more of a phone number for the user 132 associated with the communication device 104, an email address for the user 132 associated with the communication device 104, an instant message name for the user 132 associated with the communication device 104, and a user name for the user 132 associated with the communication device 104. The server component 106 comprises an instance of a recordable data storage medium 128. The server component 106 in one example employs the identifier to search the database 110 to make the determination of the internet protocol address of the router component 116. The server component 106 in one example passes the message or call through the internet 114 to the router component 116.

The router component 116 obtains the message or call from the server component 106. The server component 108 in one example employs the router component 116 to direct the message or call to one or more of the communication devices 104. For example, the router component 116 directs the message or call to one or more of the telephonic device 120, the computer 122, the television 124, the smart appliance 126, the voice mail box, and the answering machine. The server component 108 or the router component 116 in one example assigns an internet protocol address to the communication devices 104. For example, the internet protocol addresses of the communication devices 116 comprise one or more static internet protocol addresses or dynamic internet protocol addresses. The communication devices 104 register one or more internet protocol addresses of the communication devices 104 with the router component 116. The communication devices 104 may later re-register with the router component 116 to ensure reliability of internet protocol translation of the communication devices 104.

In one example, the server component 108 employs the identifiers of the communication devices 104 to direct the message or call through the router component 116 to the one or more of the telephonic device 120, the computer 122, the television 124, the smart appliance 126, the voice mailbox, and the answering machine. For example, the server component 108 employs the identifiers to search the database 112 to make a determination of the internet protocol addresses of the communication devices 104. In another example, the router component 116 directs the message or the call to the internet protocol addresses of the one or more of the telephonic device 120, the computer 122, the television 124, the smart appliance 126, the voice mailbox, and the answering machine.

Where the message or call comprises the telephone call, the voice message, or the answering machine message, the server component 108 and/or the router component 116 in one example directs the telephone call or the voice message to the telephonic device. For example, the telephonic device comprises an internet telephone that communicates with the router component 116 through voice over internet protocol (“VoIP”). In another example, where the message or call comprises the email, the instant message, or the video message, the server component 108 and/or the router component 116 directs the email, the instant message, or the video message through the router component 116 to the computer 122. In yet another example, where the message or call comprises the video message, the server component 108 and/or the router component 116 directs the video message to the television 124. In still another example, where the message or call comprises the instruction, the server component 108 and/or the router component 116 directs the instruction to the smart appliance 126. For example, the server component 108 directs the instruction to the smart appliance 126 through the router component 116 to trigger one or more functions of the smart appliance 126.

The server component 108 in one example employs the database 112 to direct the message or the call to the communication devices 104. The database 112 in one example stores one or more screening preferences of the users 132 for direction of the message or call though the router component 116 to the communication devices 104 by the server component 108. The screening preferences in one example comprise one or more of a forwarding preference, an alert preference, a preference for one or more of the communication devices 104, and a preference for the voice mailbox or the answering machine. The users 132 in one example employ the computer 122 to enter the message or call screening preferences into the database 112. The server component 108 in one example employs the screening preferences to direct the message or call through the router component 116 to the one or more of the telephonic device 120, the computer 122, the television 124, the smart appliance 126, the voice mailbox, and the answering machine.

The server component 108 in one example employs the message or call to perform a search of the screening preferences stored in the database 112. The server component 108 employs one or more results of the search to direct the message or call through the router component 116 to the one or more the telephonic device 120, the computer 122, the television 124, the smart appliance 126, the voice mailbox, and the answering machine.

In one example, where the screening preference comprises the forwarding preference, the server component 108 directs the message or call to another communication device. For example, the other communication device is connected to another router component 116 in another location. In another example, where the screening preferences comprise the alert preferences, the server component 108 directs the communication devices 104 to employ a different ring tone or message alert for the message or call. For example, a first user 132 responds to a first ring tone of the telephonic device 120, and a second user 132 responds to a second ring tone of the telephonic device 120. In yet another example, where the screening preferences comprise the preference for one or more of the communication devices 104, the server component 108 directs the message or call to one or more specific communication devices 104. For example, the first user 132 receives calls at a first telephonic device 120, and the second user 132 receives calls at a second telephonic device 120. In still another example, where the call screening preferences comprise the preference for the voice mailbox or the answering machine, the server component 108 directs the message or call to the voice mailbox or the answering machine. For example, the user 132 does not wish to talk to the user 130 who sent the message or call.

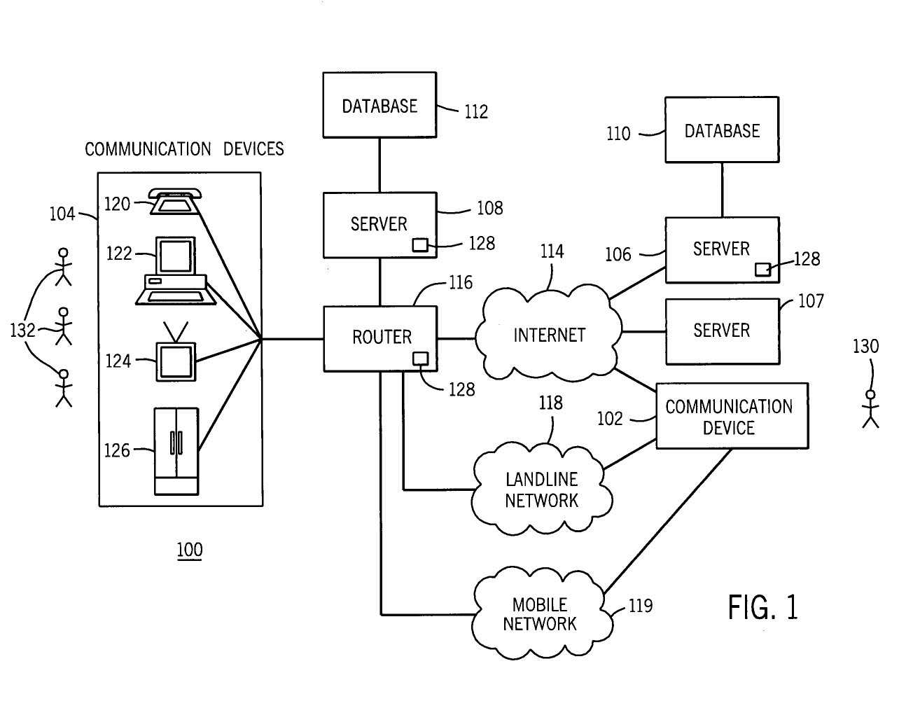

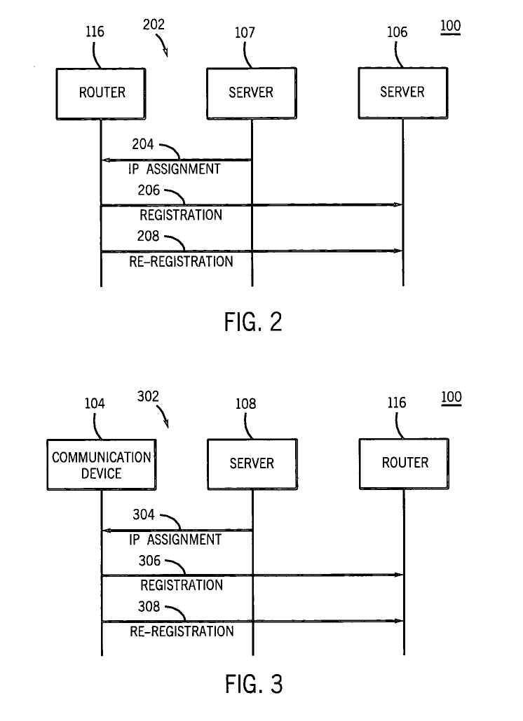

An illustrative description of an exemplary operation of the apparatus 100 is presented. Referring to FIGS. 1 and 2, message flow 202 represents an exemplary assignment and registration of one or more internet protocol addresses by the server component 107 and the router component 116. For example, the router component 116 registers an internet protocol address of the router component 116 with the server component 106.

The server component 107 in one example assigns an internet protocol address 204 to the router component 116. For example, the internet protocol address 204 comprises a dynamic internet protocol address. “IP ASSIGNMENT” in one example serves to represent the internet protocol address 204.

Upon receipt of the internet protocol address 204, the router component 116 registers an internet protocol address 206 with the server component 106. For example, the internet protocol address 206 comprises a dynamic internet protocol address or a static internet protocol address. “REGISTRATION” in one example serves to represent registration of the internet protocol address 206 with the server component 106. The router component 116 in one example periodically re-registers an internet protocol address 208 with the server component 106. For example, the router component 116 periodically re-registers the internet protocol address 208 to ensure an accurate representation of the internet protocol address 208 of the router component 116 at the server component 106. “RE-REGISTRATION” in one example serves to represent re-registration of the internet protocol address 208 with the server component 106.

Referring to FIGS. 1 and 3, message flow 302 represents an exemplary assignment and registration of one or more internet protocol addresses by the server component 108, the communication device 104 at the router component 116. For example, the communication device 104 registers an internet protocol address of the communication device 104 with the router component 116. The server component 108 in one example assigns an internet protocol address 304 to the communication device 104. For example, the internet protocol address 304 comprises a dynamic internet protocol address. “IP ASSIGNMENT” in one example serves to represent the internet protocol address 304.

Upon receipt of the internet protocol address 304, the communication device 104 registers an internet protocol address 306 with the router component 116. For example, the internet protocol address 306 comprises a dynamic internet protocol address or a static internet protocol address. “REGISTRATION” in one example serves to represent registration of the internet protocol address 306 with the router component 116. The communication device 104 in one example periodically re-registers an internet protocol address 308 with the router component 116. For example, the communication device 104 periodically re-registers the internet protocol address 308 to ensure an accurate representation of the internet protocol address 308 of the communication device 104 at the router component 116. “RE-REGISTRATION” in one example serves to represent re-registration of the internet protocol address 308 with the router component 116.

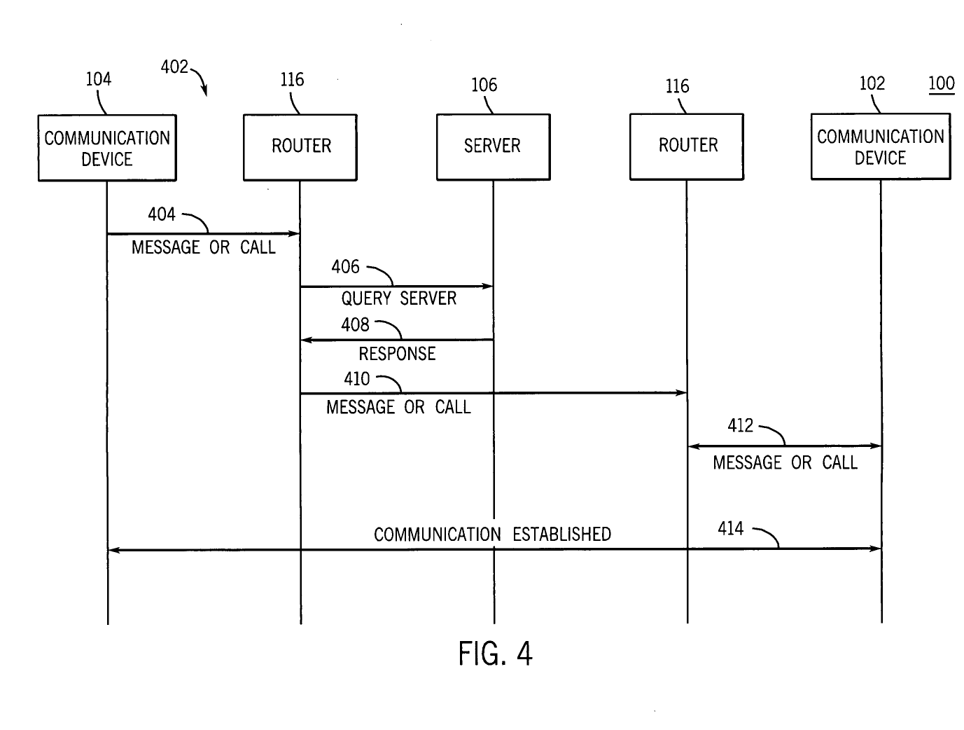

Referring to FIGS. 1 and 4, message flow 402 represents a communication of one or more messages or calls between the communication devices 102 and 104, the server component 106, and the router components 116. For example, the user 132 sends a message or a call from the communication device 104 to the first router component 116. A first router component 116 in one example sends the message or call to the server component 106. The server component 106 in one example employs the message or call to make a determination of an internet protocol address of a second router component 116. The first router component 116 passes the message or call through the server component 106 to the internet protocol address of the second router component 116. The second router component 116 passes the message or call to the communication device 102. Upon receipt of the message or call at the communication device 102, a communication link in one example is established between the communication device 102 and the communication device 104.

The user 132 in one example employs the communication device 104 to send the message or call 404 to the first router component 116. For example, the message or call 404 comprises a voice over internet protocol call. “MESSAGE OR CALL” in one example serves to represent the message or call 404. Upon receipt of the message or call 404, the first router component 116 in one example queries the server component 106 with an identifier 406 of the communication device 102. For example, where the message or call 404 comprises the voice over internet protocol call, the identifier 406 comprises a phone number of the communication device 102. “QUERY SERVER” in one example serves to represent the identifier 406 of the communication device 102.

Upon receipt of the identifier 406, the server component 106 in one example searches a database to make the determination of the internet protocol address 408 of the second router component 116. The server component 106 responds to the first router component 116 with the internet protocol address 408. “RESPONSE” in one example serves to represent the internet protocol address 408. Upon receipt of the internet protocol address 408, the first router component 116 in one example sends a message or the call 410 to the second router component 116. For example the message or call 410 comprises the message or call 404 with the internet protocol address of the second router component 116. “MESSAGE OR CALL” in one example serves to represent the message or call 410.

Upon receipt of the message or call 410 from the first router component 116, the second router component 116 in one example sends a message or a call 412 to the communication device 102. For example, the router component 116 employs an internet protocol address of the communication device 102 to send the message or call 412 to the communication device 102. “MESSAGE OR CALL” in one example serves to represent the message or call 412 for the communication device 102. Upon receipt of the message or call 412, a connection 414 in one example is established between the communication device 102 and the communication device 104. “COMMUNICATION ESTABLISHED” in one example serves to represent the connection 414. The user 132 of the communication device 104 is able to communicate with the user 130 of the communication device 104 in the voice over internet protocol call.

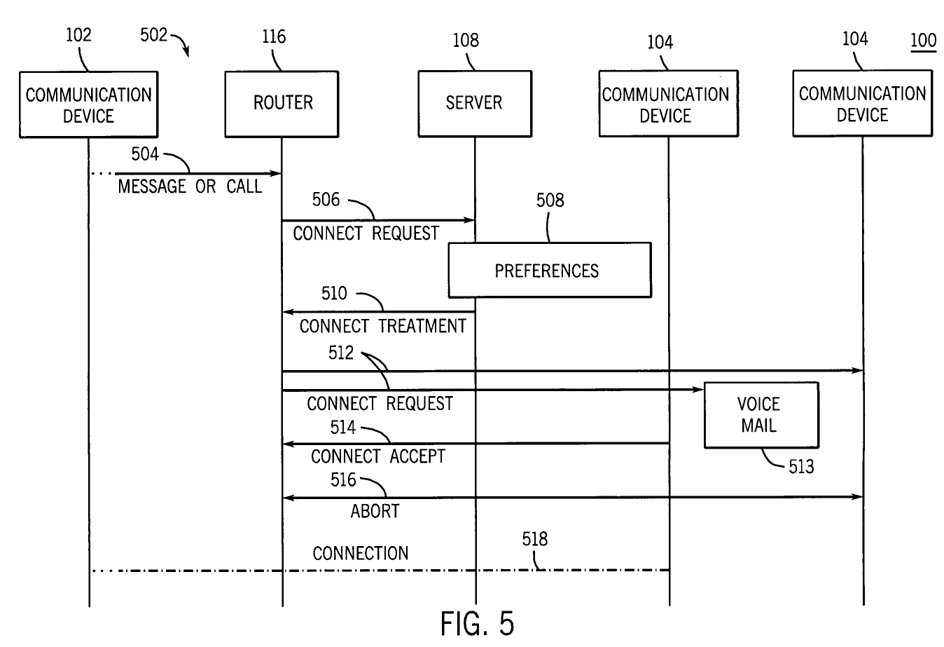

Referring to FIGS. 1 and 5, message flow 502 represents a communication of one or more messages or calls between the communication devices 102 and 104, the router component 116, and the server component 108. For example, the user 130 sends a message or a call from the communication device 102 to the router component 116. The router component 116 in one example sends the message or call to the server component 108. The server component 108 in one example employs one or more of the message or call and one or more screening preferences of the users 132 of the communication devices 104 to direct the message or call to a first communication device 104 and second communication device 104. The router component 116 in one example passes the message or call to a first communication device 104 and the second communication device 104. Upon receipt of the message or call at the communication device 104, a communication link in one example is established between the communication device 102 and the first communication device 104.

The user 130 in one example employs the communication device 102 to send the message or call 504 to the router component 116. “MESSAGE OR CALL” in one example serves to represent the message or call 504. Upon receipt of the message or call 504, the router component 116 in one example queries the server component 108 with a portion of the message or call 506. For example, the router component 116 queries the server component 108 to make a determination 508 of the first communication device 104 and the second communication device 104. “CONNECT REQUEST” in one example serves to represent the portion of the message or call 506.

Upon receipt of the portion of the message or call 506, the server component 108 employs one or more of the portion of the message or call 506 and the screening preferences to make the determination 508 of one or more of the first communication device 104 and the second communication device 104. In one example, the server component 108 employs the one or more of the portion of the message or call 506 and the screening preferences to determine one or more internet protocol addresses of the communication devices 104. In another example, the screening preferences comprise one or more preferences for the one or more of the first communication device 104 and the second communication device 104. For example, the server component 108 employs the one or more of the portion of the message or call 506 and the alert preferences to determine to send the message or call 504 to the one or more of the communication devices 104. In yet another example, the screening preferences comprise one or more preferences for a voice mailbox. For example, the server component 108 employs the one or more of the portion of the message or call 506 and the screening preferences to determine to send the message or call 504 to the voice mailbox. “PREFERENCES” in one example serve to represent the determination 508 of the one or more of the first communication device 104 and the second communication device 104.

The server component 108 in one example sends one or more preferences 510 of the message or call 504 to the router component 116. “CONNECT TREATMENT” in one example serves to represent the preferences 510 of the message or call 504. Upon receipt of the preferences 510, the router component 116 sends a request 512 for a connection with the message or call 504 to the one or more of the first communication device 104 and the second communication device 104 and/or the voice mailbox. “CONNECT REQUEST” in one example serves to represent the request 512 for the connection with the message or call 504.

Upon receipt of the request 512 by the voice mailbox, the user 130 of the communication device 102 in one example can leave a voice message 513 for the user 132. “VOICE MAIL BOX” in one example serves to represent the message 513 for the user 132. Upon receipt of the request 512 by the first communication device 104, the first communication device 104 in one example sends an accept message 514 to the router component 116. “CONNECT ACCEPT” in one example serves to represent the accept message 514 for the router component 116. Upon receipt of the request 512 by the second communication device 104, the second communication device 104 in one example sends an abort message 516 to the router component 116. For example, if the first communication device 104 already accepts the message or call 504, the second communication device 104 sends the abort message 514. “ABORT” in one example serves to represent the abort message 514 for the router component 116. Where the first communication device 104 sends the accept message 514, a connection 518 in one example is established between the communication device 102 and the first communication device 104. “COMMUNICATION ESTABLISHED” in one example serves to represent the connection 518.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage medium 128 of the server components 106 and 108 and the router component 116. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
one or more server components that employ one or more identifiers of one or more communication devices to make a determination of one or more internet protocol addresses of one or more router components, wherein the one or more identifiers comprise any one or more of:
a phone number for one or more users associated with the one or more communication devices;
an email address for the one or more users associated with the one or more communication devices;
an instant message name for the one or more users associated with the one or more communication devices; and
a user name for the one or more users associated with the one or more communication devices.

2. The apparatus of claim 1, wherein the one or more server components employ the one or more identifiers to search one or more databases to make the determination of the one or more internet protocol addresses of the one or more router components.

3. The apparatus of claim 2, wherein one or more of the one or more internet protocol addresses of one or more of the one or more router components comprise one or more dynamic internet protocol address of the one or more of the one or more router components;
wherein one or more of the one or more server components search one or more of the one or more databases to make a determination of the one or more dynamic internet protocol addresses of the one or more of the one or more router components.

4. The apparatus of claim 2, wherein one or more of the one or more internet protocol addresses of one or more of the one or more router components comprise one or more static internet protocol address of the one or more of the one or more router components;
wherein one or more of the one or more server components search one or more of the one or more databases to make a determination of the one or more static internet protocol addresses of the one or more of the one or more router components.

5. The apparatus of claim 1, wherein upon the determination by the one or more server components of the one or more internet protocol addresses of the one or more router components, one or more of the one or more server components communicate one or more messages or calls through the internet to the one or more internet protocol addresses of the one or more router components.

6. The apparatus of claim 5, wherein one or more of the one or more messages or calls comprise one or more video messages;
wherein upon the determination by the one or more server components of the one or more internet protocol addresses of the one or more router components, the one or more of the one or more server components communicate the one or more video messages through the internet to one or more of the one or more internet protocol address of one or more of the one or more router components.

7. The apparatus of claim 5, wherein the one or more of the one or more server components comprise one or more first server components, the apparatus in combination with:
one or more second server components that employ the one or more identifiers of the one or more communication devices to direct the one or more messages or calls through the one or more router components to the one or more communication devices.

8. The apparatus of claim 7, wherein one or more of the one or more second server components employ one or more screening preferences of one or more of the one or more users associated with one or more of the one or more communication devices to direct one or more of the one or more messages or calls to the one or more of the one or more communication devices.

9. The apparatus of claim 8, wherein the one or more screening preferences are stored in one or more databases, wherein the one or more of the one or more second server components employ the one or more of the one or more messages or calls to perform a search of the one or more screening preferences, wherein the one or more of the one or more second server components employ one or more results of the search to direct the one or more of the one or more messages to the one or more of the one or more communication devices.

10. The apparatus of claim 7, wherein one or more of the one or more router components are coupled with a landline telephone network;
wherein one or more of the one or more second server components direct one or more landline telephone calls from the landline telephone network through one or more of the one or more router components to one or more of the one or more communication devices.

11. The apparatus of claim 7, wherein one or more of the one or more router components are coupled with a mobile network;
wherein one or more of the one or more second server components direct one or more mobile phone calls from the mobile network through one or more of the one or more router components to one or more of the one or more communication devices.

12. The apparatus of claim 7, wherein the one or more of the one or more communication devices comprise one or more smart appliances with one or more functions;
wherein one or more of the one or more second server components direct one or more of the one or more messages or calls through one or more of the one or more router components to trigger one or more of the one or more functions of the one or more smart appliances.

13. The apparatus of claim 1 further comprising:
one or more mobile communication devices;
wherein upon the determination by the one or more server components of the one or more internet protocol addresses of the one or more router components, the one or more mobile communication devices employ an H.323 protocol to communicate one or more messages or calls through the internet to one or more of the one or more internet protocol address of one or more of the one or more router components.

14. The apparatus of claim 1, wherein the one or more of the one or more server components comprise one or more first server components;
wherein the one or more first server components employ the one or more identifiers to search one or more databases to make the determination of the one or more internet protocol addresses of the one or more router components;
wherein upon the determination by the one or more first server components of the one or more internet protocol addresses of the one or more router components, one or more of the one or more first server components communicate one or more messages or calls through the internet to the one or more internet protocol addresses of the one or more router components;
the apparatus further comprising:
one or more second server components;
wherein upon receipt of the one or more messages or calls at the one or more router components, the one or more second server components employ the one or more identifiers of the one or more communication devices to direct the one or more messages or calls through the one or more router components to the one or more communication devices.

15. A method, comprising the steps of:
searching one or more databases with one or more identifiers of one or more communication devices to make a determination of one or more internet protocol addresses of one or more router components; and
sending one or more messages or calls to the one or more internet protocol addresses of the one or more router components for direction to the one or more communication devices.

16. The method of claim 15, wherein one or more of the one or more internet protocol addresses of the one or more router components comprise one or more dynamic internet protocol addresses of one or more of the one or more router components, wherein the step of searching the one or more databases with the one or more identifiers of the one or more communication devices to make the determination of the one or more internet protocol addresses of the one or more router components comprises the steps of:
searching one or more of the one or more databases make the determination of the one or more dynamic internet protocol addresses of the one or more of the one or more router components; and
sending one or more of the one or more messages or calls through the internet to the one or more dynamic internet protocol addresses of the one or more of the one or more router components.

17. The method of claim 15, wherein one or more of the one or more internet protocol addresses of the one or more router components comprise one or more static internet protocol addresses of one or more of the one or more router components, wherein the step of searching the one or more databases with the one or more identifiers of the one or more communication devices to make the determination of the one or more internet protocol addresses of the one or more router components comprises the steps of:
searching one or more of the one or more databases to make the determination of the one or more static internet protocol addresses of the one or more of the one or more router components; and
sending one or more of the one or more messages or calls through the internet to the one or more static internet protocol addresses of the one or more of the one or more router components.

18. The method of claim 15, wherein the one or more communication devices comprise one or more smart appliances, wherein the step of sending the one or more messages or calls to the one or more internet protocol addresses of the one or more router components for direction to the one or more communication devices comprises the step of:
triggering one or more functions of the one or more smart appliances through direction of one or more of the one or more messages or calls through one or more of the one or more router components.

19. The method of claim 15, wherein the one or more databases comprise one or more first databases, wherein the step of sending the one or more messages or calls to the one or more internet protocol addresses of the one or more router components for direction to the one or more communication devices comprises the steps of:
searching one or more second databases to direct one or more of the one or more messages or calls to one or more of the one or more communication devices;
directing the one or more of the one or more communication messages to the one or more of the one or more communication devices through employment of one or more of the one or more identifiers and one or more message screening preferences of one or more users of the one or more communication devices.

20. The method of claim 15, wherein one or more of the one or more communication messages comprise one or more video messages, wherein the step of sending the one or more messages or calls to the one or more internet protocol addresses of the one or more router components for direction to the one or more communication devices comprises the steps of:
communicating the one or more video messages through the internet to the one or more internet protocol address of the one or more router components.

21. An article, wherein one or more identifiers comprise any one or more of a phone number, an email address, an instant message name, and a user name of user associated with a communication device, comprising:
one or more computer-readable signal-bearing media;
means in the one or more media for searching one or more databases with the one or more identifiers of one or more communication devices to make a determination of one or more internet protocol addresses of one or more router components; and
means in the one or more media for sending one or more messages or calls to the one or more internet protocol addresses of the one or more router components for direction to the one or more communication devices.
